(19) United States
(12) Patent Application Publication
(10) Pub. No.: US 2015/0242593 A1
(43) Pub. Date: Aug. 27, 2015

(54) SYSTEM AND METHOD FOR GENERATING SURVEY QUESTIONS

(71) Applicant: MAP Health Management, LLC, Austin, TX (US)

(72) Inventors: Jacob Levenson, Austin, TX (US); Ali Bagheri, Austin, TX (US); Tod Meinke, Austin, TX (US); Michael F. Conwell, Austin, TX (US); Tom Kimball, Austin, TX (US)

(73) Assignee: MAP Health Management, LLC, Austin, TX (US)

(21) Appl. No.: 14/627,814

(22) Filed: Feb. 20, 2015

Related U.S. Application Data
(60) Provisional application No. 61/942,976, filed on Feb. 21, 2014.

(51) Int. Cl. G06F 19/00

(52) U.S. Cl. CPC G06F 19/363

(57) ABSTRACT

The present disclosure relates to a system and method for generating survey questions, and to a system and method for managing behavioral health using the same.

### REFERENCE TO RELATED APPLICATION

This disclosure claims priority to U.S. Provisional Application 61/942,976 filed Feb. 21, 2014; which is hereby incorporated by reference in its entirety.

### FIELD OF THE INVENTION

Embodiments usable within the scope of the present disclosure relate, generally, to methods and systems for management of behavioral health of an individual, and more specifically, to the aforementioned which include methods and systems for generating survey questions and surveying individuals.

### BACKGROUND OF THE INVENTION

Management of behavioral health of individuals is typically limited to services provided during in-person office visits with therapists, psychologists and psychiatrists.

### BRIEF SUMMARY OF THE INVENTION

The present disclosure relates to adaptive systems and methods for management of behavioral health of and individual, and which may include adaptive systems and methods for generating survey questions and surveying an individual. Subject matter disclosed herein is further directed to adaptive systems and methods for management of behavioral health of individuals, and which may include systems and methods for generating survey questions and surveying individuals, wherein questions asked of the individuals may be dynamically tailored to variables, such as attributes of an individual, usable with an adaptive model of an individual.

Embodiments may enable an interactive experience for the survey participant, thus increasing the likelihood of maintaining the survey participant's involvement for a prolonged period of time.

The present disclosure provides adaptive systems and methods for management of behavioral health of an individual which may include adaptive systems and methods for generating survey questions that may provide, for example, to a surveyor, upon entering information (e.g., credentials) related to an individual who is to be surveyed, a dynamically adjusting or adaptive list, inventory, queue or priority listing of questions and information requirements relevant and specific to the individual. Such an adaptive providing of questions and information requirements may be generated dynamically, and thus may change on the fly, in real-time or near real-time, as answers to questions and information are repeatedly provided to an adaptive priority model of an individual. Such an adaptive priority model of an individual may include a large number of variables relating to or correlated with behavior of an individual, such as behavioral health of an individual who is recovering from addiction or other behavioral health issues.

In an embodiment, the dynamic adjusting question list includes a number of fixed questions.

In an embodiment, the question list includes interest questions.

The present disclosure may be of particular benefit in the medical field, and more particularly in the field of addictive substance or symptom rehabilitation. As part of a patient's rehabilitation following, for example, a period of substance abuse, the patient must be questioned at periodic intervals. As such, it may be desirable to ensure that the patient remains interested and invested in the questions/questionnaires that are presented, both to increase the reliability and accuracy of the results obtained, and to increase the likelihood of patient compliance.

Embodiment of the present disclosure may enable a computer aided survey mechanism for the questioning of targets who are participants in a drug rehabilitation program, which may predict the statistical likelihood of a target individual relapsing.

In an embodiment of the present disclosure, the statistical likelihood is determined on the basis of a target's attributes and the correlating score for each attribute. In yet a further embodiment, the score relating to each attribute is multiplied by a mitigating factor.

In an embodiment of the present disclosure, the system may prepare warning messages for identifying targets that have been statistically determined by the system to possess a risk of relapse in excess of a certain value or threshold.

In an embodiment of the present disclosure, the system may transmit the warning message to key personnel, relatives, or contacts, associated with the target deemed to be of high risk.

An embodiment of the present disclosure enables a system and method of creating and managing and health contracts.

Embodiments may include systems and methods for generating individualized and/or filtered sets of questions from a larger repository of questions, for various purposes for which a survey and/or questionnaire may be desired (e.g., political, medical, entertainment, etc.)

These and other features, aspects, and advantages of the present invention will become better understood with reference to the following description and any claims appended to a subsequent application.

### BRIEF DESCRIPTIONS OF THE DRAWINGS

The novel features believed characteristic of the disclosed subject matter will be set forth in the claims. The disclosed subject matter itself, however, as well as a preferred mode of use, further objectives, and advantages thereof, will best be understood by reference to the following detailed description of an illustrative embodiment when read in conjunction with the accompanying drawings, wherein:

FIG. 1 presents a flow chart diagram of an exemplary application of the present disclosure wherein the target may be questioned along one of two question streams;

FIG. 2 presents a diagram of an exemplary system according to an embodiment;

FIG. 3 presents a flow chart diagram illustrating aspects of subject matter according to an embodiment;

FIG. 4 presents a flow chart diagram of an exemplary embodiment of aspects of the present disclosure wherein the target is questioned under a returning target question stream;

FIG. 5 presents a flow chart of an exemplary embodiment of the present disclosure and a method for generating and displaying a Question List;

FIG. 6 presents a flow chart illustrating aspects of a method according to an embodiment;

FIG. 7 presents a flow chart illustrating aspects of a method according to an embodiment;

FIG. 8A depicts an exemplary output system;

FIG. 8B depicts an exemplary output system;

FIG. 8C depicts an exemplary output system;

FIG. 9 presents a flow chart illustrating aspects of a method according to an embodiment;

FIG. 10 presents a flow chart illustrating aspects of a method according to an embodiment;

FIG. 11 presents a flow chart illustrating aspects of a method according to an embodiment;

FIG. 12 presents a flow chart illustrating aspects of a system according to an embodiment;

FIG. 13 presents a flow chart illustrating aspects of a method according to an embodiment;

FIG. 14 presents a flow chart illustrating aspects of a method according to an embodiment;

FIG. 15 presents a flow chart illustrating aspects of a system according to an embodiment.

FIG. 16 presents a flow chart illustrating aspects of a method according to an embodiment.

In the FIGURES, like elements should be understood to represent like elements, even though reference labels are omitted on some instances of a repeated element, for simplicity.

### DETAILED DESCRIPTION OF ILLUSTRATIVE EMBODIMENTS

Reference now should be made to the drawings, in which the same reference numbers are used throughout the different figures to designate the same components.

For the purposes of the present disclosure, the term target is intended to refer to any individual who is subject to a process that may include eliciting responses to one or multiple questions on more than one occasion. A specific example of a repetitive question program may include eliciting responses from patients, and the patient's connections (e.g., family members), who are participating in a drug rehabilitation program. This may include but is not limited to: the patient, their sponsor, their contact at transitional living centers, their spouse or significant other, mother, father, sibling or friend(s).

For the purposes of the present disclosure, the term questioner is intended to represent the method by which questions, e.g., of a survey, are asked of a target. An exemplary embodiment of a questioner could be an individual, such as a medical practitioner. In another embodiment, the questioner could be an electronic device, such as a computer or tablet device executing software that causes presentation of questions, directly or indirectly, to a target. In other embodiments, the questioner could include printed or written material.

The term attribute is intended to represent any characteristic falling into a discrete or a predefined range by which the target may be classified relative to a population, group of individuals, or as data within a database. Examples of attributes include but are not limited to: social relations, i.e. marital status, number of children, etc; biological characteristics, i.e. age, weight, addiction, height; and historical characteristics, i.e. medical history, past voting history, etc. Other possible attributes by which an individual may be classified relative to a larger group that are not expressly described herein but are known in the art at the present time are intended to be included within the scope of the present disclosure.

The term question is intended to represent the asking of a pre-defined question of a survey participant. The question or questions may include a set having as little as one question, with no limitation on the maximum number of questions, other than the practicality of keeping a target engaged in the survey. Questions included in the present disclosure may be generic, specifically targeted to a target and/or random questions.

While specific embodiments are provided with respect to drug rehabilitation programs, embodied methods and systems could equally be applied to any other area in which eliciting responses to questions is desired, such as chronic health problems, i.e. heart disease, obesity, asthma, diabetes, mental health conditions, etc.

For the purposes of the present disclosure, the term rules is intended to represent the rules by which specific questions operate. These rules may determine how questions relate to one or more attributes associated with a target. Exemplary rules corresponding to a question may include: to whom the question is asked i.e. the patient or a relative of the patient; how frequently the Question is asked, i.e. only once, every six months, at initiation, etc.; specific attributes that may prevent a question from being presented (e.g., a question not asked of male participants), questions that must precede the question, with or without eliciting a specific response; questions that must follow the question; and numerous other examples.

For the purposes of the present disclosure, the term question medium is intended to represent any means, mode, apparatus or system by which a question or a series of questions may be presented to a target.

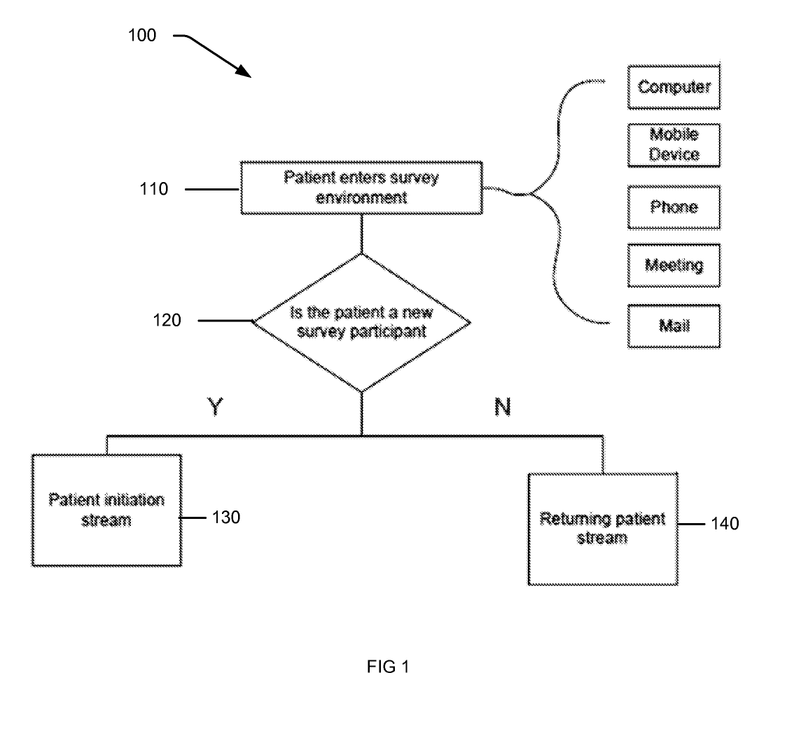

FIG. 1 presents an exemplary methodology for conducting a survey whereby the target entering the survey environment 110 may be categorized as either a returning target 140, or a new target 130. The “survey environment” may include any situation or location in which the questioner is able to present the questions to the target. For the purposes of the present disclosure, the survey environment is intended to include any methodology permitting at least two-way communication between the target and the individual or device conducting the questioning with examples including but not limited to: telephone interviews, face to face interviews, computer aided surveys, mobile or tablet surveys, and/or mailed surveys, and any other methods known in the art.

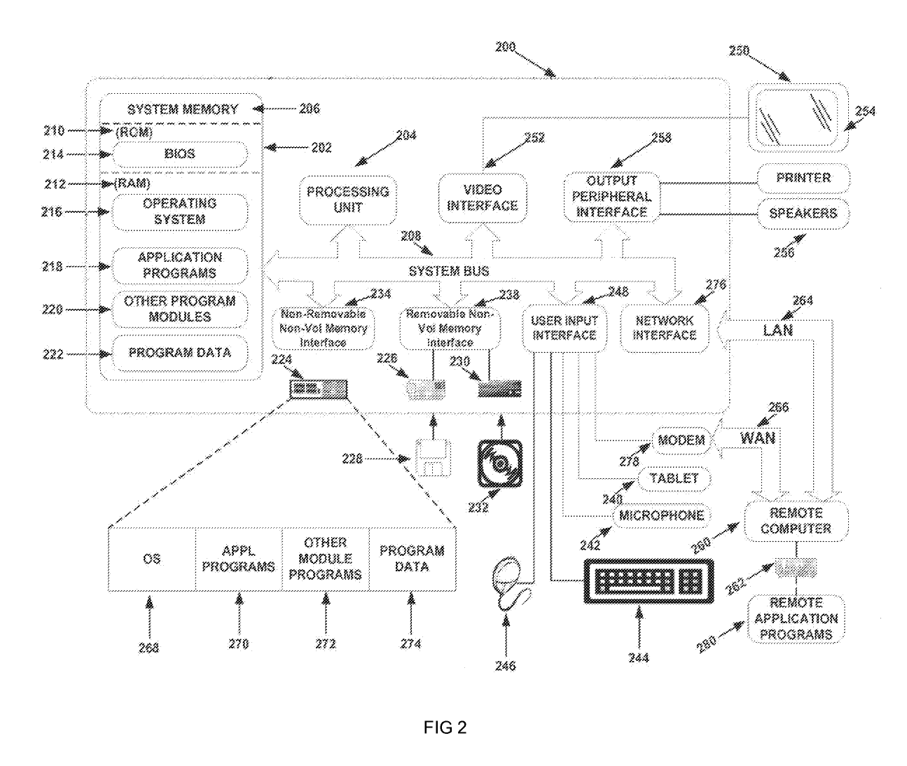

Illustrated in FIG. 2 is an exemplary system according to an embodiment of the present disclosure. With reference to FIG. 2, an exemplary system within a computing environment for implementing the invention includes a general purpose computing device in the form of a computing system 200, commercially available from Intel, IBM, AMD, Motorola, Cyrix and others. Components of the computing system 202 may include, but are not limited to, a processing unit 204, a system memory 206, and a system bus 236 that couples various system components including the system memory to the processing unit 204. The system bus 236 may be any of several types of bus structures including a memory bus or memory controller, a peripheral bus, and a local bus using any of a variety of bus architectures.

Computing system 200 typically includes a variety of computer readable media. Computer readable media may be any available media that may be accessed by the computing system 200 and includes both volatile and nonvolatile media, and removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data.

Computer memory includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by the computing system 200.

The system memory 206 includes computer storage media in the form of volatile and/or nonvolatile memory such as read only memory (ROM) 210 and random access memory (RAM) 212. A basic input/output system 214 (BIOS), containing the basic routines that help to transfer information between elements within computing system 200, such as during start-up, is typically stored in ROM 210. RAM 212 typically contains data and/or program modules that are immediately accessible to and/or presently being operated on by processing unit 204. By way of example, and not limitation, an operating system 216, application programs 220, other program modules 220 and program data 222 are shown.

Computing system 200 may also include other removable/non-removable, volatile/nonvolatile computer storage media. By way of example only, a hard disk drive 224 that reads from or writes to non-removable, nonvolatile magnetic media, a magnetic disk drive 226 that reads from or writes to a removable, nonvolatile magnetic disk 228, and an optical disk drive 230 that reads from or writes to a removable, nonvolatile optical disk 232 such as a CD ROM or other optical media could be employed to store the invention of the present embodiment. Other removable/non-removable, volatile/nonvolatile computer storage media that may be used in the exemplary operating environment include, but are not limited to, magnetic tape cassettes, flash memory cards, digital versatile disks, digital video tape, solid state RAM, solid state ROM, and the like. The hard disk drive 224 is typically connected to the system bus 236 through a non-removable memory interface such as interface 234, and magnetic disk drive 226 and optical disk drive 230 are typically connected to the system bus 236 by a removable memory interface, such as interface 238.

The drives and their associated computer storage media, discussed above, provide storage of computer readable instructions, data structures, program modules and other data for the computing system 200. For example, hard disk drive 224 is illustrated as storing operating system 268, application programs 270, other program modules 272 and program data 274. Note that these components may either be the same as or different from operating system 216, application programs 220, other program modules 220, and program data 222. Operating system 268, application programs 270, other program modules 272, and program data 274 are given different numbers hereto illustrates that, at a minimum, they are different copies.

A user may enter commands and information into the computing system 200 through input devices such as a tablet, or electronic digitizer, 240, a microphone 242, a keyboard 244, and pointing device 246, commonly referred to as a mouse, trackball, or touch pad. These and other input devices are often connected to the processing unit 204 through a user input interface 248 that is coupled to the system bus 208, but may be connected by other interface and bus structures, such as a parallel port, game port or a universal serial bus (USB).

A monitor 250 or other type of display device is also connected to the system bus 208 via an interface, such as a video interface 252. The monitor 250 may also be integrated with a touch-screen panel or the like. Note that the monitor and/or touch screen panel may be physically coupled to a housing in which the computing system 200 is incorporated, such as in a tablet-type personal computer. In addition, computers such as the computing system 200 may also include other peripheral output devices such as speakers 254 and printer 256, which may be connected through an output peripheral interface 258 or the like.

Computing system 200 may operate in a networked environment using logical connections to one or more remote computers, such as a remote computing system 260. The remote computing system 260 may be a personal computer, a server, a router, a network PC, a peer device or other common network node, and typically includes many or all of the elements described above relative to the computing system 200, although only a memory storage device 262 has been illustrated. The logical connections depicted include a local area network (LAN) 264 connecting through network interface 276 and a wide area network (WAN) 266 connecting via modem 278, but may also include other networks. Such networking environments are commonplace in offices, enterprise-wide computer networks, intranets and the Internet.

The central processor operating pursuant to operating system software such as IBM OS/2®, Linux®, UNIX®, Microsoft Windows®, Apple Mac OSX® and other commercially available operating systems provides functionality for the services provided by the present invention. The operating system or systems may reside at a central location or distributed locations (i.e., mirrored or standalone).

Software programs or modules instruct the operating systems to perform tasks such as, but not limited to, facilitating client requests, system maintenance, security, data storage, data backup, data mining, document/report generation and algorithms. The provided functionality may be embodied directly in hardware, in a software module executed by a processor or in any combination of the two.

Furthermore, software operations may be executed, in part or wholly, by one or more servers or a client's system, via hardware, software module or any combination of the two. A software module (program or executable) may reside in RAM memory, flash memory, ROM memory, EPROM memory, EEPROM memory, registers, hard disk, a removable disk, a CD-ROM, DVD, optical disk or any other form of storage medium known in the art. An exemplary storage medium is coupled to the processor such that the processor may read information from, and write information to, the storage medium. In the alternative, the storage medium may be integral to the processor. The processor and the storage medium may also reside in an application specific integrated circuit (ASIC). The bus may be an optical or conventional bus operating pursuant to various protocols that are well known in the art.

Data shared and/or used in the various embodiments may also be shared and/or used via a traditional web site or to populate a web site (or other medium). This allows information already assembled in one or more of the other embodiments to be repurposed and thereby raise the value of the disclosed subject matter.

Examples of computing devices such as that depicted in FIG. 2 may include, but are not limited to, portable or mobile devices such as mobile phones (including smartphones), laptop computers, tablet computers, personal digital assistants (PDAs), or non-portable devices such as desktop computers, servers, mainframes, and the like. Such computing devices include, in some examples, various components, such as one or more processors, input devices, communication devices, output devices, storage devices, communications busses, or other components. Each of the components may be interconnected (physically, communicatively, and/or operatively) for inter-component communications. In some examples, the one or more processors of a computing device may execute an operating system that controls operations of components of the computing device, such as by facilitating communication between components of the computing device.

Processors of the computing device, in some examples, are configured to implement functionality and/or process instructions within the computing device. For instance, one or more processors of the computing device may be capable of processing instructions stored in one or more storage devices of the computing device. Examples of such processors may include any one or more of a microprocessor, a controller, a digital signal processor (DSP), an application specific integrated circuit (ASIC), a field-programmable gate array (FPGA), or other equivalent discrete or integrated logic circuitry.

One or more storage devices of a computing device may be configured to store information within the computing device during operation. Such storage devices may be described as computer-readable storage media. In some examples, a computer-readable storage medium may include a non-transitory medium. The term “non-transitory” may indicate that the storage medium is not embodied in a carrier wave or a propagated signal. In certain examples, a non-transitory storage medium may store data that may, over time, change (e.g., in RAM or cache). In some examples, a storage device may be a temporary memory, meaning that a primary purpose of the storage device is not long-term storage. Storage devices, in some examples, may be described as volatile memory, meaning that the storage device does not maintain stored contents when power to the computing device is turned off. Examples of volatile memories may include random access memories (RAM), dynamic random access memories (DRAM), static random access memories (SRAM), and other forms of volatile memories. In some examples, a storage device may be used to store program instructions for execution by one or more processors. Storage devices, in certain examples, may be used by software or applications running on the computing device to temporarily store information during program execution.

Storage devices, in some examples, also include one or more computer-readable storage media. Storage devices may be configured to store larger amounts of information than volatile memory. Storage devices may further be configured for long-term storage of information. In some examples, storage devices may include non-volatile storage elements. Elements of such non-volatile storage elements may include magnetic hard discs, optical discs, floppy discs, flash memories, or forms of electrically programmable memories (EPROM) or electrically erasable and programmable (EEPROM) memories.

A computing device can, in some examples, include one or more communication devices. For instance, a computing device may utilize a communication device to communicate with external devices via one or more networks, such as wired or wireless networks or both. A communication device may be a network interface card, such as an Ethernet card, an optical transceiver, a radio frequency transceiver, or any other type of device that may send and receive information. Other examples of such network interfaces may include, but are not limited to, Bluetooth, 3G, 4G, WiFi radio computing devices, as well as Universal Serial Bus (USB).

In certain examples, a computing device may utilize a communications device to communicate with one or more external devices via a communications network. In some examples, components of Platform may be distributed among multiple computing devices, which may be interconnected via the communications network. Examples of such a communications network may include one or more wired or wireless networks or both, such as local area networks (LANs), wireless local area networks (WLANs), cellular networks, wide area networks (WANs) such as the Internet, or other types of networks.

A computing device may also include one or more input devices and/or output devices. An input device, in some examples, may be configured to receive input from a user. Examples of input devices may include any one or more of a mouse, a keyboard, a microphone, a camera device, a presence-sensitive and/or touch-sensitive display, or other type of device configured to receive input from a user. Output devices may be configured to provide output to a user. Examples of output devices may include a display device, a sound card, a video graphics card, a speaker, a cathode ray tube (CRT) monitor, a liquid crystal display (LCD) an organic light emitting diode (OLED) display, or other type of device for outputting information.

Accordingly, techniques of this disclosure may be implemented by one or more computing devices implementing computer-readable instructions that, when executed, cause the one or more computing devices to perform operations attributed to the exemplary computing system. The exemplary computing system is further described below within the context of various scenarios, illustrations, and further description.

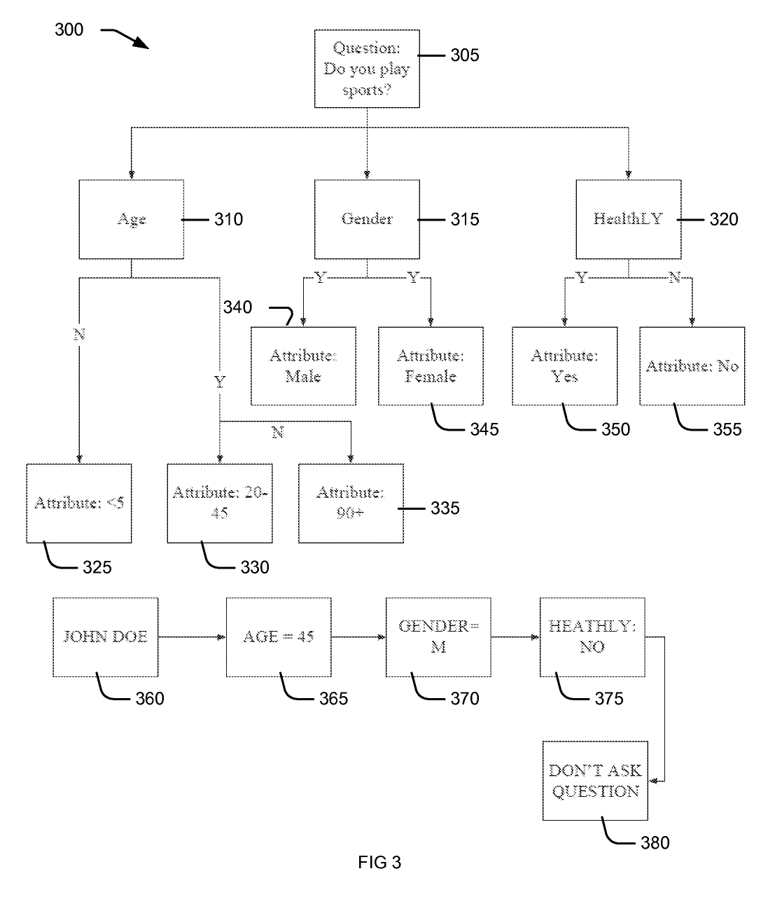

FIG. 3 presents an exemplary methodology relating to the assigning of rules for questions. In the depicted example, the system may determine whether to ask the question 305: “Do you play Sports?” Depending on the attributes of the target 310, 315, 320, i.e. age, gender, or health of the target, the system will either disregard this question as unsuitable, or retain this question to potentially be presented to the target. In this exemplary situation, the target's attributes of age 310 and gender 315 match the rules however the target's ‘health’ 320 attribute does not. Accordingly, the question will not be included in the list of possible questions to be presented to the target at this time.

In one embodiment of the present disclosure, a system contains a plurality of questions on a database. For the purposes of the present disclosure, the questions list contained on the database may be identified as the master question list.

In an exemplary embodiment of the present disclosure the system correlates the target's attributes to the master question list to determine a target question list, e.g., by filtering and/or discarding certain questions from the master question list using the target's attributes. The resulting target question list may include as little as one question, or as many as all questions contained in the master question list.

In some embodiments of the present disclosure, the number of questions contained on the target question list will be limited to a predefined number (e.g., six questions, twenty questions, etc., which may be determined based on the purpose of the questioning).

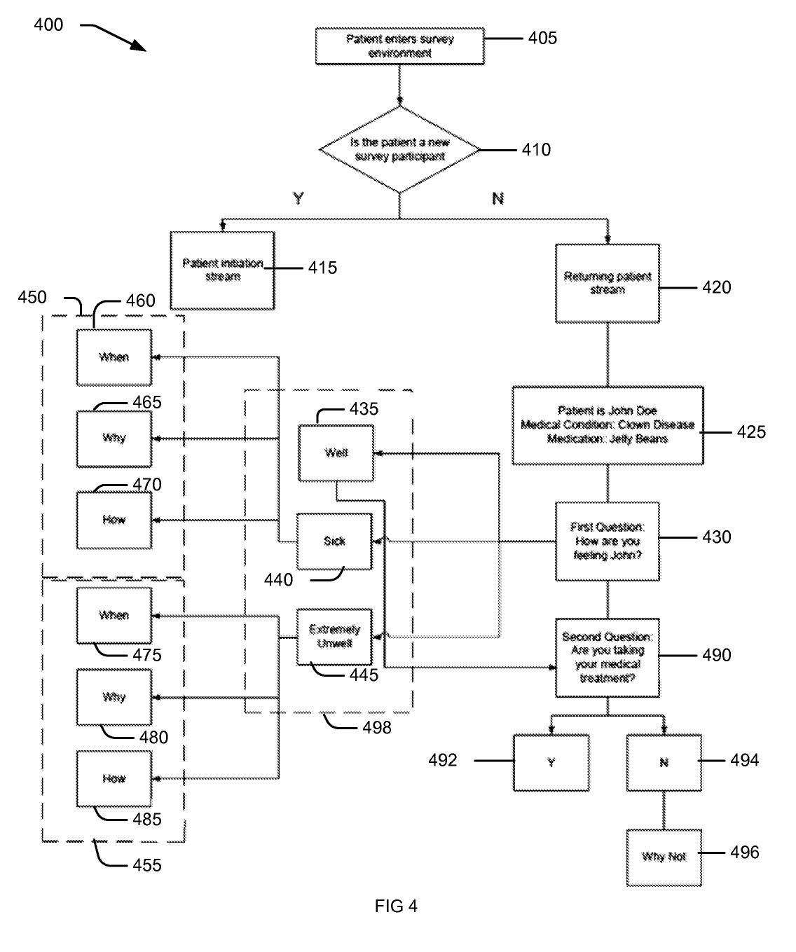

FIG. 4 presents an exemplary methodology for conducting a returning target questioning stream. Upon ascertaining that the target is a returning survey participant 420, the target's credentials are queried and then verified by the system 425. Upon verification of the target's credentials, the system provides the target question list to the questioner, which then presents the questions 430 and receives the target's responses 498 In an embodiment, because the target is a returning survey participant, questions only suitable for presentation to a new survey participant (e.g., questions relating to basic demographic data and/or establishment of basic attributes, such as age, gender, etc.) may be filtered from the target question list.

In one embodiment, presentation of the target question list may include presentation of a single question at a time, with a response being required before a subsequent question is added to the target question list. In other embodiments, the target question list may contain a plurality of questions, which may be dynamically adjusted upon receipt of one or more response. Questions from the target question list may be presented to the target individually (e.g., one question at a time), or all or a portion of the target question list may be presented at one time. In other embodiments, selection, filtering, and/or presentation of subsequent questions may occur independent of responses to previous questions.

In some embodiments, a database will contain information on the target. This information could be acquired as part of a patient's initiation questioning, prior medical history, and/or from responses received from previous questions.

In the exemplary embodiment presented in FIG. 4, the system is able to determine that the target is a patient named John Doe, that the target has a known medical condition, and that the target is taking medication 425. Accordingly, on the basis that the patient is known to be taking medication, a possible attribute rule example would be “is the patient feeling unwell,” 430, whereupon the patient provides a response matching into a predefined category, i.e. well, sick, extremely unwell 498. Following the receipt of the target's response and depending on the attributing of the response, the system may be able to either propose a subsequent follow-up question 490, i.e. “how are you feeling unwell”, or alternatively, could determine to ask a subsequent unrelated question, i.e. “are you taking your medical treatment.”

The example provided above could also be categorized as a fixed rule question, in embodiments where the determination of the patient's health may be linked to a key performance criteria of the questioning of the target.

In yet other embodiments, the above example could also be used as a random question, or as an ice breaker, in embodiments where the determining of the target's health is not a key performance criteria, i.e. political surveying.

Embodiments of the present disclosure are dynamically adjustable in relation to the content of the questions, the number of questions asked, the manner by which the questions are presented, and the manner by which the questions are arranged.

In one embodiment, questions are linked to optional or required attributes by way of inserting records into a defined data table and assigning identification numbers. Identification numbers associate each question with a set of variables that defines the requirements. For example, a sizeable database of questions, each assigned certain rules, attributes, etc., may be filtered using the attributes stored in association with a target. Based on the target's attributes (e.g., gender, age, responses to questions during previous survey sessions, etc.), certain questions in the database may be discarded as unsuitable. Additionally or alternatively, based on independent, question-based attributes, such as a desired frequency for which the question should be presented (e.g., only once, once per eight survey sessions, etc.), certain questions in the database may be discarded as unsuitable. Questions that remain suitable may be further filtered using other factors/attributes, and/or using random selection, to arrive at the preselected number of questions for the target question list. In an embodiment, one or more questions may be preset as core and/or mandatory questions that will be present on the target question list independent of target attributes.

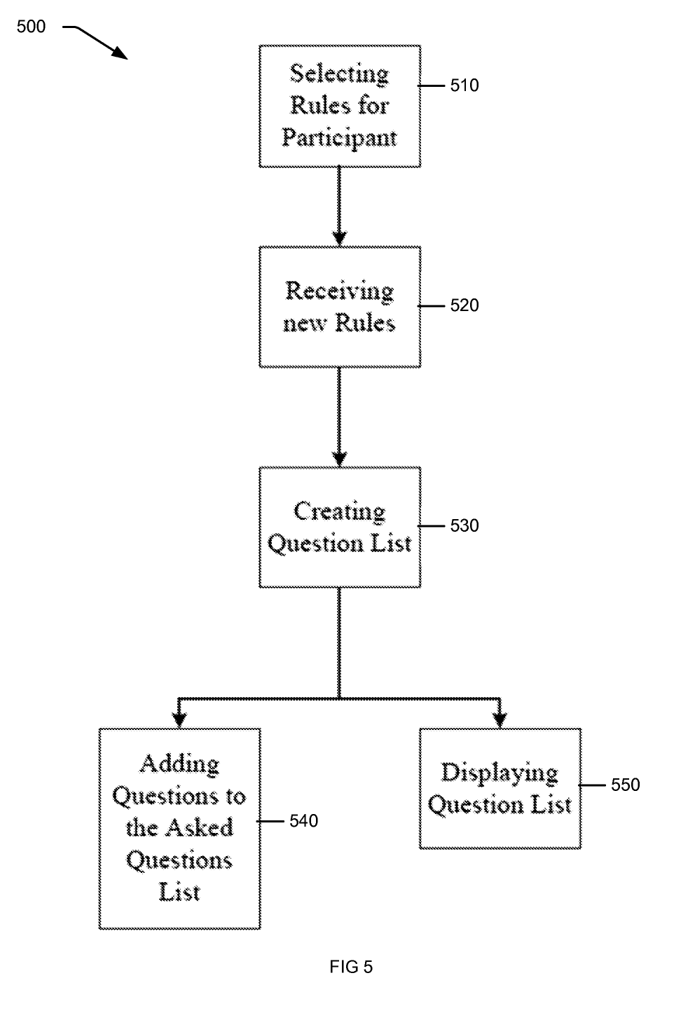

FIG. 5 depicts a method of generating and displaying a questions list. Wherein rules are selected for the participant 510. Any new rules are added to the database associated with the participant 520. The question list for that participant may be generated based on the rules associated with the participant 530. These questions may either be displayed 550, or additional questions may be added to the question list 540.

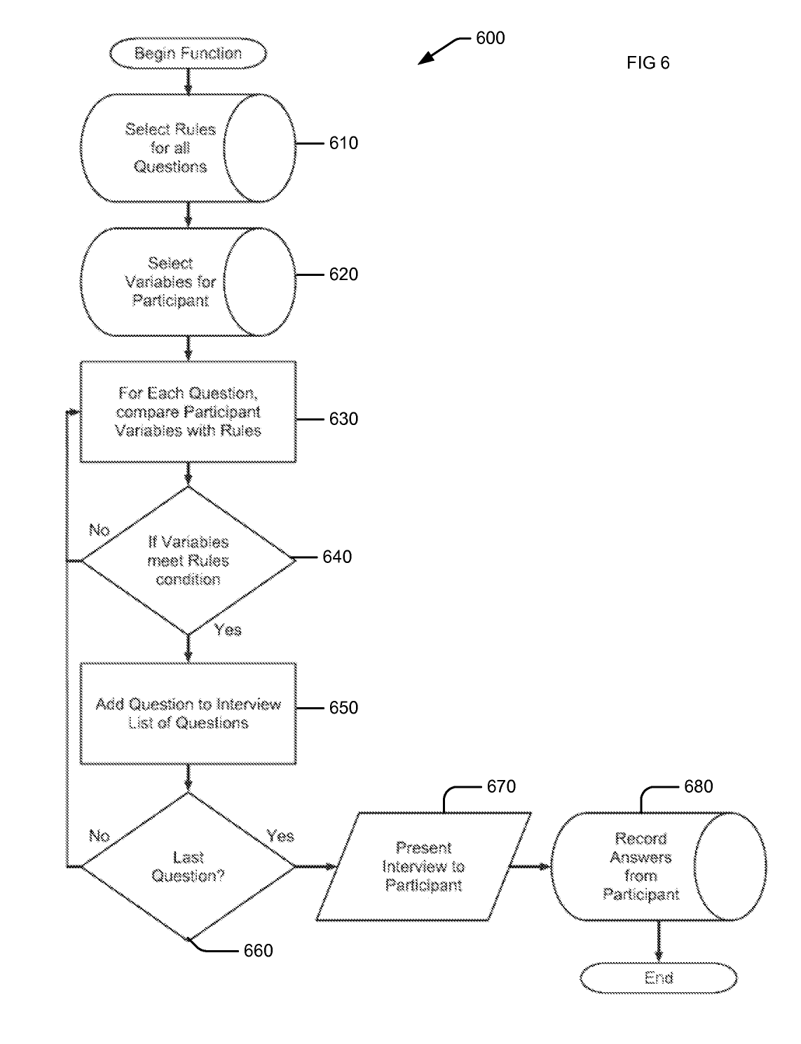

FIG. 6 presents a flow chart diagram of the system steps in an exemplary embodiment of the present disclosure.

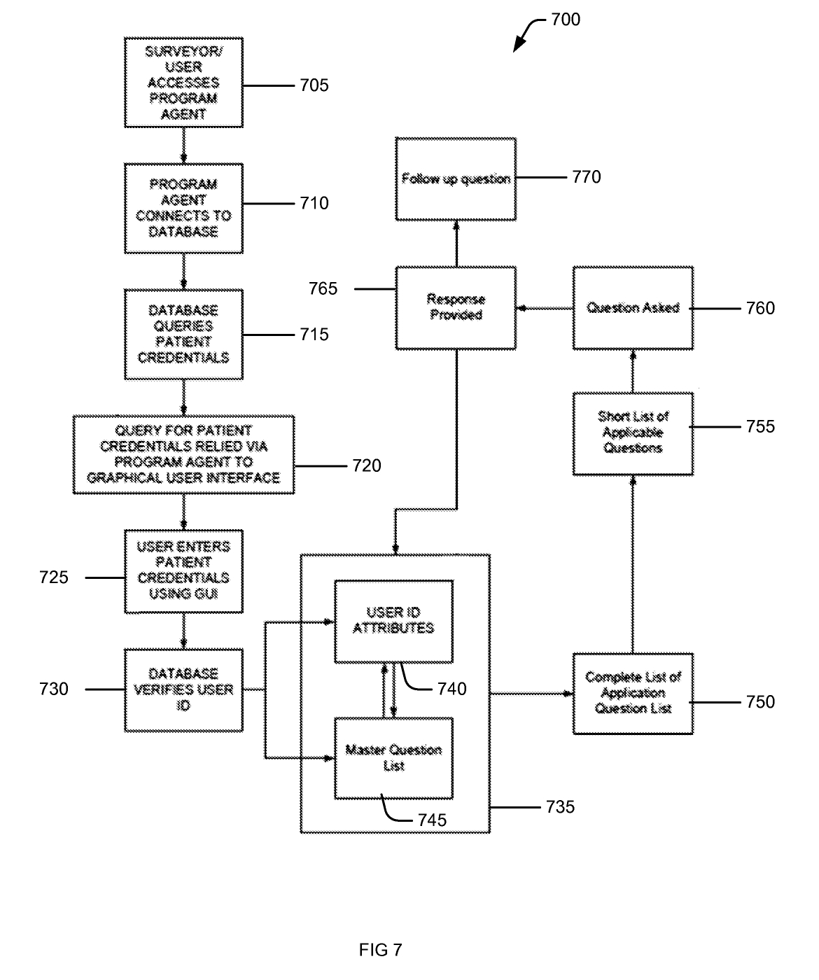

FIG. 7 presents an exemplary embodiment of the present disclosure wherein a system may be able to utilize the target's attributes 740 to determine the questions that are applicable to the target's circumstances 755. For instance, an exemplary embodiment of this attribute targeting is the ability of the system to ask a specific question of targets that meet the age requirement of between 25 to 40 yr old, and who are also male.

Further in reference to FIG. 7, the flowchart portrays one embodiment of the present disclosure from the system's perspective. In this example, a system has a database that contains the master question list, as well the responses entered by previous targets. In this example, each question within the master question list may be assigned an attribute or rule, which governs how the question operates. For instance, a question querying the target's credentials, i.e. name, may be assigned a rule or attribute that limits the asking of the question to the first interview. In this example, the system receives a request indicating a new target is to be questioned. The system then queries its database and transmits to the question medium the questions whose rules match an initial questioning scenario. The questions are then presented to the target via the question medium and the responses are received, entered into the database, and the appropriate attributes are assigned.

In another example, a question may be assigned an attribute that governs how frequently the question may be asked. For instance, a question may only be presented to a target at every odd numbered interview, i.e. on the first interview, third interview, etc. In alternative embodiments, the frequency of questioning may be linked to a time period, i.e. a question is asked every six months, regardless of the number of interviews the target has participated in during this period.

In other embodiments of the present disclosure, attributes assigned to a target may include the previous questioned asked of the target, responses to previous questions, and when one or more previous questions were asked.

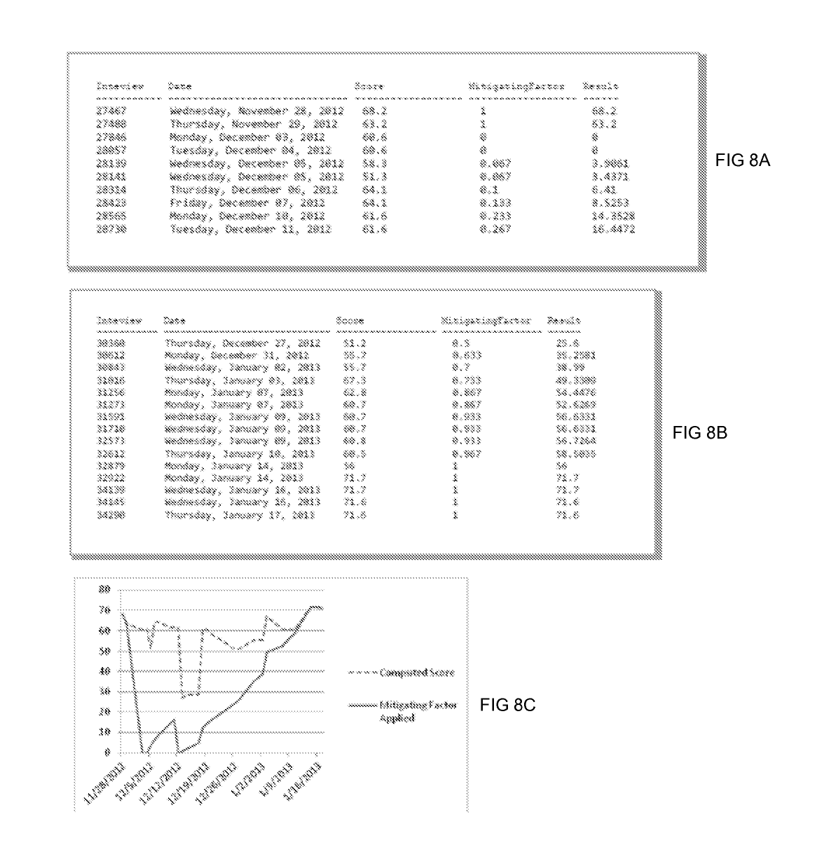

FIGS. 8A, 8B, and 8C present exemplary outputs of a system capable of scoring the targets' responses to questions.

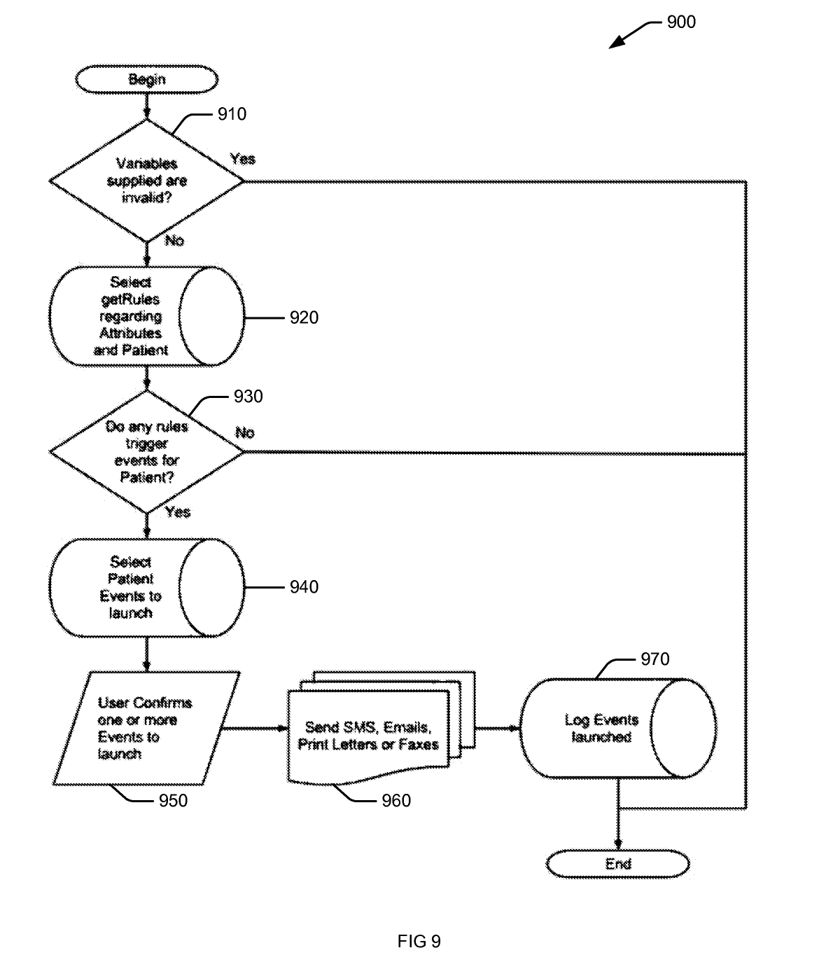

FIG. 9 presents a flow chart of another embodiment of the present disclosure wherein the system may prepare and send warning messages 960. As shown, in this embodiment the system runs a protocol 930 to determine if the patient responses to questions trigger any attributes and/or variables which are of concern, or are flagged as a response of concern. An example of this would be asking of the target “are you self harming” with a response of “yes”. In another embodiment, the system may compare the responses of the target to multiple preset criteria, with the combination of responses triggering a notice or flag within the system if a certain threshold or combination of responses is received. An example of this would be learning from the target that the target had resumed smoking, had a recent job change and a new personal relationship.

In the embodiment presented in FIG. 9, the system, upon determining that the target is triggering a flag 940, attribute of concern, etc., operates a protocol 950 to trigger the sending of a message 960. This message then seeks confirmation from an approved user, which may be the Questioner or medical practitioner, etc., whereupon receipt of the confirmation the message is sent.

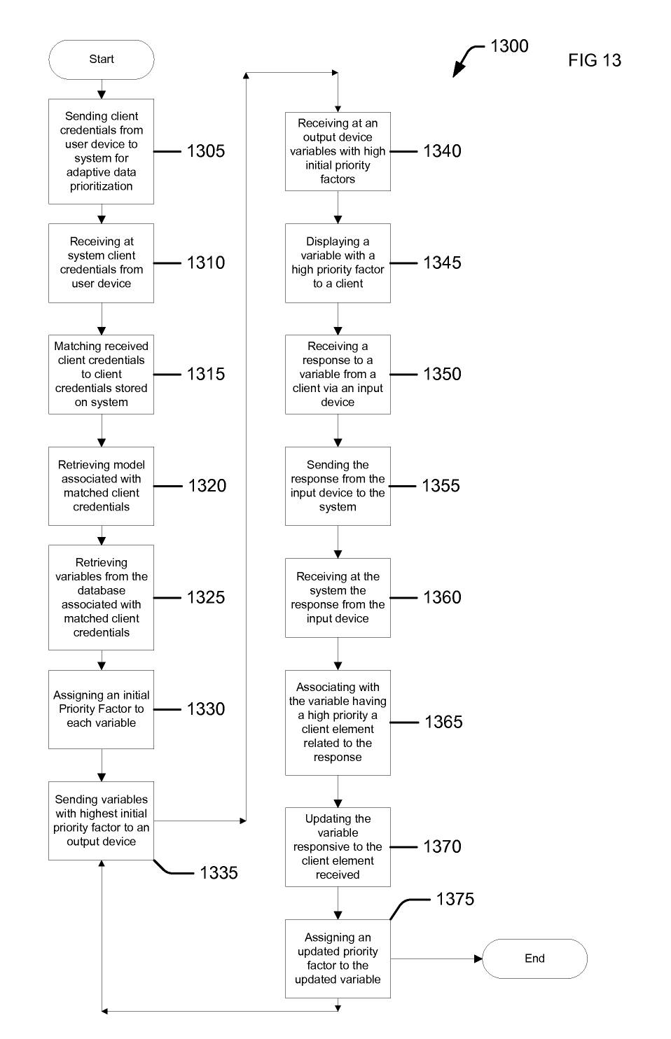

FIG. 9 presents a flow chart of an exemplary system responding to a returning patient interview. As shown, the system receives a query from a network that indicates a returning target is participating in an interview. The system then communicates to the question medium a request for target verification, i.e. login details, name, age, etc., which in the example presented in FIG. 13 may be provided by the graphical user interface, hereafter GUI, which may be associated with the target. The response may therefore be entered into the GUI and then transmitted to the system that contains the database. Upon verification of the target's attributes, the system compares the rules assigned to the questions (within the master question list) to the attributes associated with the target. This comparison identifies the questions which return a match enabling preparation of a target's question list. This question list may then be transmitted to the question medium and then presented to the target.

In one embodiment, the question medium asks each question contained with the question list sequentially before the responses are recorded within the database and additional target's attributes are assigned. In other embodiments, the question medium may individually ask each question, record each question response, and assign the appropriate attribute, before the next question in the target's question list may be queried. In yet other embodiments, the entering of the target's responses may result in the target question list being dynamically adjusted as a result of the target's response to one or more previous questions.

In yet another embodiment, the system database may also include rules that limit the number of questions to be asked of the target, which may be dependent on the rules assigned to the target, or the stage of the interview process regarding the target, i.e. first interview, second interview, etc. For instance, in the exemplary situation, where a target is known to be a participant in a drug rehabilitation program, the system may limit the number of questions to 20 to avoid lengthy periods of daily questioning. In this example, if the target's question list exceeds a rule defining the number of questions to be asked, the system may either select the questions considered to be of highest priority, and/or select questions randomly, or by other governing system rules. In an alternative example, the filtering of the target's attributes against the master question list rules may return a target question list less than that required by the system. In this example, the system may then include a number of random questions, and/or consider a secondary rule set that may introduce further questions.

In a further embodiment, the method and system disclosed are capable of sourcing additional information relating to the target by questioning of the target's associates. Examples of the target's associates may include health practitioners, relatives and partners. In yet a further embodiment, the responses by the target's associates may be assigned specific attributes defining the nature of their relationship to the target, in addition to the assigning of the response attributes.

In this embodiment presented, the system may be capable of assigning a numerical score to the target based upon the value of the attributes assigned to the target and the associates' responses. In one example, the system tallies a score by summing the value assigned to each attribute to achieve a numerical value between 1 and 100. In another example, each value assigned to the attributes may be multiplied by a mitigating value before being summed to achieve the target's numerical value, whilst in yet another embodiment, each value may be summed before a mitigating value is applied to the sum to achieve the target's numerical value. The target's numerical value represents the perceived likelihood of an event occurring to or by the target. Specific examples of these particularly events may include: likelihood of relapse, likelihood of self-harm, likelihood of voting for a particular candidate or representation.

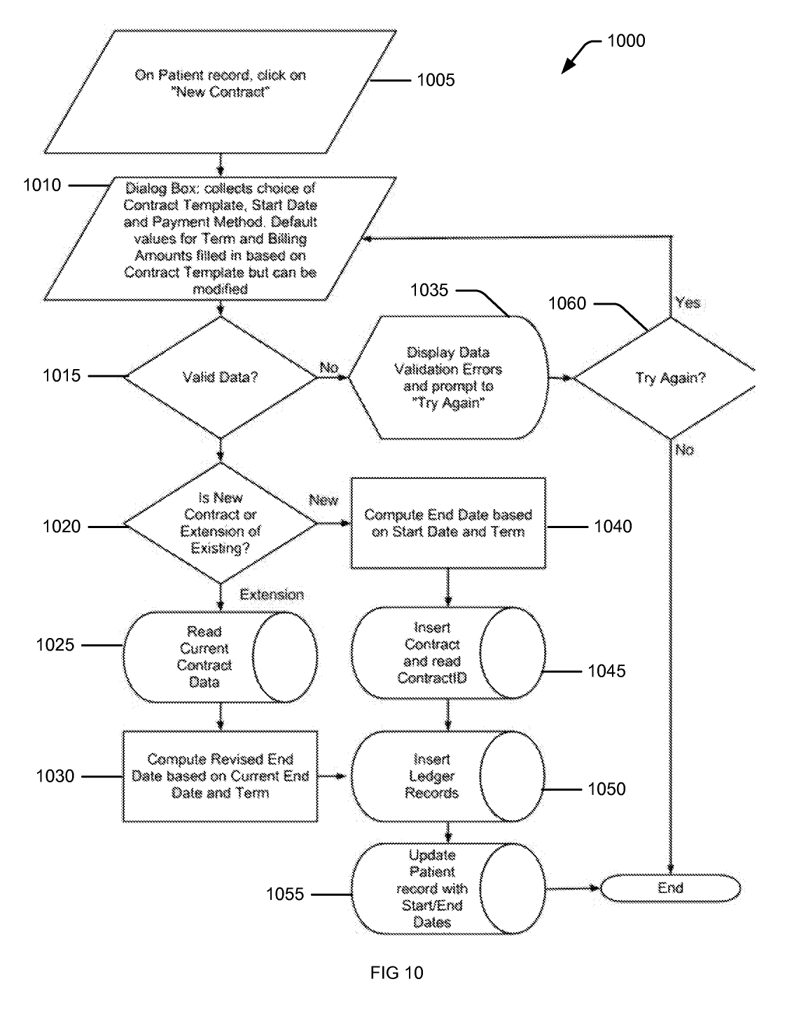

FIG. 10 presents a flow chart of a method for managing billing and payment for services by a health insurance provider or other carrier who may be financially responsible for the services provided to a patient.

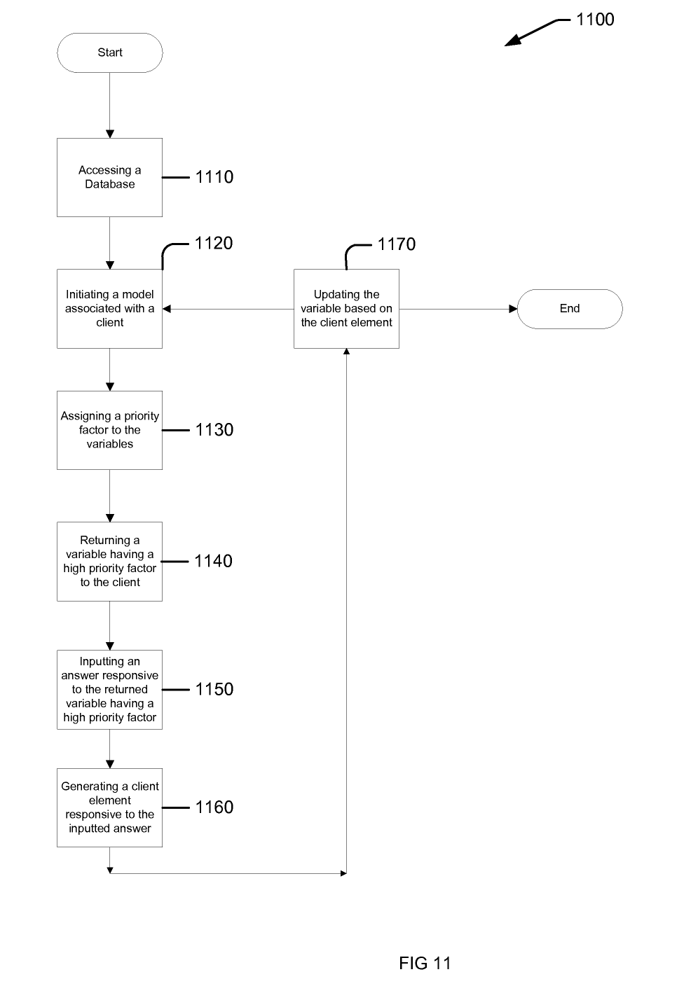

Referring to FIG. 11, method 1100 for performing adaptive data prioritization may include the step of accessing 1110 a data record of a patient, where the data record includes a plurality of patient variables. It will be understood that the individual may be a person, subject or patient whose behavioral health is to be monitored or managed by functioning of a suitable method 1500 for management of behavioral health of individuals, and by functioning of a system 1600 for management of behavioral health of individuals. A suitable data record of an individual can be stored in accessible form in a suitable patient database. Such a patient database may be secured as disclosed elsewhere herein by issuing access credentials only to persons authorized by an individual or patient, or in any manner suitable for limiting access to data records of individuals in compliance with applicable regulations to provide privacy of data records. It will be understood that one regulation which may be applicable to securing access to such data records or patient database is HIPPA.

Referring to FIG. 11, it will be understood that in the step of accessing 1110, the plurality of patient variables may be any variable which may provide or represent information related to modeling, representing, or managing the behavioral health of a patient. In embodiments, the plurality of patient variables may be any variables or values which may provide or represent information related to managing the behavioral health of a patient by having predictive value for predicting behavioral health events. It will be understood that predicted behavioral health events may include, without limitation, relapse by a patient in again using alcohol or drugs; relapse by engaging in addiction behaviors such as food addiction, eating disorders, sex addiction or gambling addiction; or other behaviors or events such as, for example, events which are precursors of relapse events; recovery events; or abstinence events. It will be understood that “predicting” may include, without limitation, that a variable is believed, theorized or known to have utility or to be of predictive value, or contribute to a model or mode, for prediction of behavioral health events by a suitable model, method or system. It will be understood that suitable patient variables may be identified, for example, as patient-specific variable information, patient-specific questions, patient-specific answers, or patient-specific elements other than answers to questions. Without limitation, examples of patient variables may include: employment status, change in employment status, consecutive days of abstinence from proscribed behaviors, reported practice of a twelve-step program, reported attendance at twelve-step meetings, reported frequency of attendance at twelve-step meetings, reporting participation in a sponsored relationship in a twelve-step program, reported severity of urges to engage in proscribed behaviors, recent relocation, proximity to family members, reported quality of relationships with family members, and income.

Referring to FIG. 11, method 1100 for performing adaptive data prioritization may include initiating 1120 an adaptive data prioritization model of a patient. In embodiments, a suitable adaptive data prioritization model may establish, define or assign for an individual or patient a model including or defining rules, weights, coefficients, logical relationships, mathematical relationships, a mathematical model, correlations, or behavioral relationships between a plurality of patient variables. It will be understood that, in embodiments, a suitable adaptive data prioritization model of a patient may include at least one algorithm embodying such a model and including or defining rules, weights, coefficients, logical relationships, mathematical relationships, a mathematical model, correlations, or behavioral relationships between a plurality of patient variables. It will be understood that, in embodiments, a suitable adaptive data prioritization model of a patient may include at least one algorithm embodying such a model and including or defining rules, weights, coefficients, logical relationships, mathematical relationships, a mathematical model, correlations, or behavioral relationships between a plurality of patient variables, and wherein the at least one algorithm provides, identifies or assigns a Priority Factor for each variable. As used herein, a Priority Factor means, and may include a calculated, determined or assigned value related to a profile variable (such as, for example, a variable of a patient model) for indicating a relative priority, need, or utility for the variable to be updated or acquired for introduction into the adaptive data prioritization model for the variable to be introduced to the adaptive data prioritization model for predicting behavioral events, such as relapse or predicted probability of relapse, for the patient being managed. It will be understood that a Priority Factor for each variable may be displayed or otherwise communicated to a medium such as a Patient Management Specialist for the specialist to query the patient to obtain patient variables information that embodies patient variables or values of patient variables. Examples of patient variables information may include a patient's direct answers to questions, inferred answers to questions, recent life events such as relocation or employment, reported mental health conditions, reported physical health conditions, reported use of prescribed medications, inferred use of prescribed medications, reported social interactions with individuals who are known to sell or use illegal substances such as drugs, reported illegal activities, inferred illegal activities, inferred use of illegal substances such as drugs or other proscribed conduct, reported practice of twelve-step programs, inferred practice of twelve-step programs, and attendance at designated appointments. It will be understood that a suitable adaptive data prioritization model, for example, may be embodied in suitable code, such as compilable software, that is stored in suitable memory to be accessed and executed by a suitable processor. It will be understood that a Priority Factor is other than the variable, or actual value or updated value of the variable, and rather is an indication of priority for the variable to be updated or input into the adaptive data prioritization model for the patient.

Referring to FIG. 11, method 1100 for performing adaptive data prioritization may include assigning 1130 a Priority Factor to each variable of an adaptive data prioritization model of a patient.

Referring to FIG. 11, method 1100 for performing adaptive data prioritization may include assigning 1130 a Priority Factor to each variable of an adaptive data prioritization model of a patient. It will be understood that assigning 1130 may include calculating or otherwise determining a Priority Factor in accordance with weighting, relative importance, or desired updating frequency, or aging of the variable since last being updated or input into the model.

Referring to FIG. 11, method 1100 for performing adaptive data prioritization may include returning 1140 a variable having a high Priority Factor to a client, such as for the variable and/or Priority Factor to be displayed or provided to a medium such as a Patient Management Specialist. As used herein, the term “high” means that a Priority Factor is greater than or equal to other Priority Factors of different variables. It will be understood that a complete listing of up to all variables and associated Priority Factor for each variable may be provided to the client. It will be understood that at least one question related to a variable can be presented to the patient by the client or Patient Management Specialist to elicit for each variable an answer providing or indicating the variable, or an update to the variable, of an adaptive data prioritization model of the patient.

Referring to FIG. 11, method 1100 for performing adaptive data prioritization may include inputting 1150 an answer responsive to a returned variable having a high Priority Factor for an adaptive data prioritization model of the patient.

Referring to FIG. 11, method 1100 for performing adaptive data prioritization may include generating 1160 a client element responsive to the inputted answer. The client element may indicate, include or update information in the patient record and/or the adaptive data prioritization model for the patient. It will be understood that the client element information is generated for use and processing in and according to updating the adaptive data prioritization model for the patient.

Referring to FIG. 11, method 1100 for performing adaptive data prioritization may include updating 1170 the variable based on the client element. The variable may be updated based on the client element indicating, including or updating information of the variable in the patient record. The updated variable may be accessed, used and/or processing in and according to the adaptive data prioritization model for the patient. It will be understood that the adaptive data prioritization model for the patient may be updated by iterations on each occasion of making use of, accessing, and/or processing each updated variable. It will be understood, accordingly, that the adaptive data prioritization model for the patient may be updated on the fly, in real-time, or near real-time after each inputted answer for the adaptive data prioritization model to make use of, access, and/or process each updated variable.

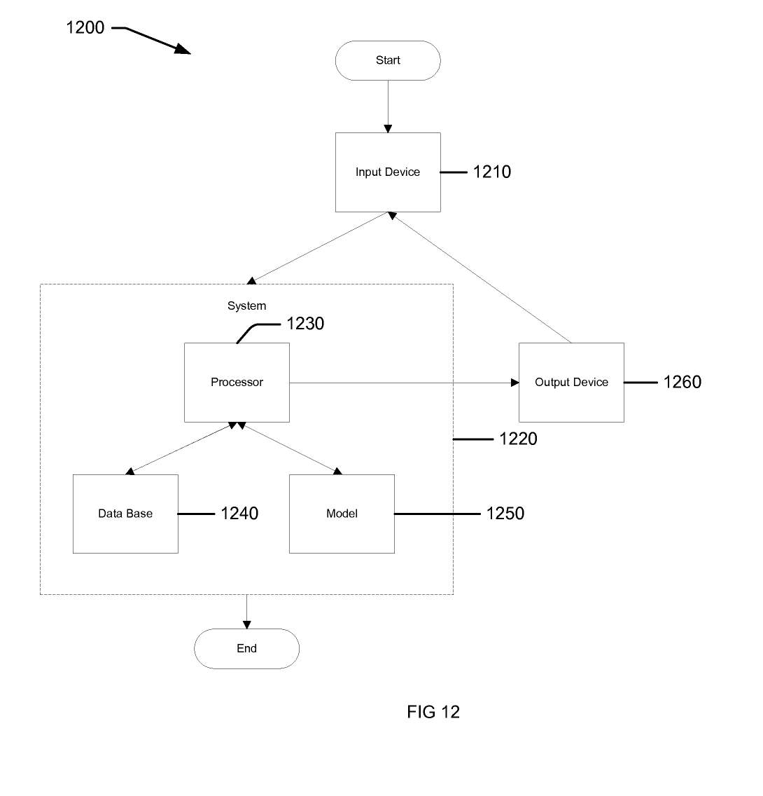

Referring to FIG. 12, according to an embodiment a system 1200 for performing adaptive data prioritization may include input device 1210 in communication with system 1220 having database 1240, processor 1230 and model 1250. Input device 1210 may be in communication with output device 1260. Output device 1260 may be in communication with processor 1230 of system 1220, and with input device 1210, for receiving and outputting or providing information, data and/or instructions. It will be understood that in embodiments system 1200 for performing adaptive data prioritization may be suitable and arranged for enabling, supporting, processing and/or performing method 1100 for performing adaptive data prioritization as shown in FIG. 11.

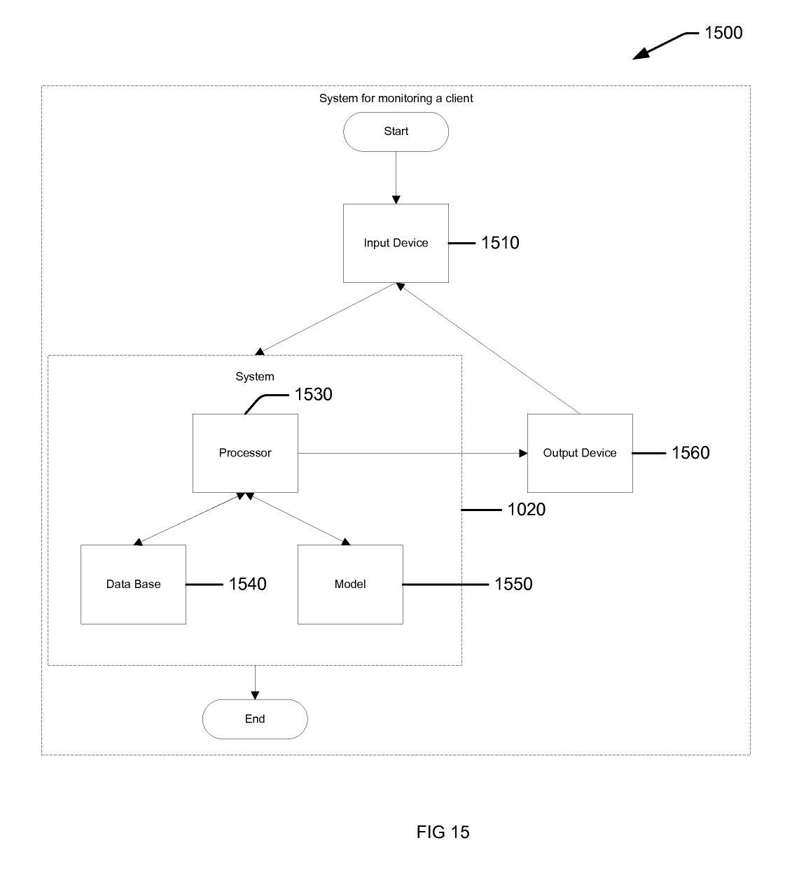

Illustrated in FIG. 13 is a method 1300 according to an embodiment of the present disclosure. Method 1300 may include sending 1305 client credentials from a user device to a suitable system for adaptive date prioritization. It will be understood that such a system for adaptive date prioritization may be included, incorporated or compatible with a suitable system 1500 (shown in FIG. 15) for management of behavioral health of an individual. Method 1300 may include receiving 1310 at a system client credentials from a user device. Method 1300 may include matching 1315 received client credentials to reference client credentials stored in a system. Method 1300 may include retrieving 1320 an adaptive date prioritization model for the patient identified by the matched credentials. Method 1300 may include retrieving 1325 variables from the client record associated with the matched credentials in a patient database. Method 1300 may include assigning 1330 an initial Priority Factor to each variable. Method 1300 may include sending 1335 variables with high initial Priority Factor to a suitable client or output device for providing to a medium such as a Patient Management Specialist. Method 1300 may include receiving 1340 receiving at an output device variables with high initial Priority Factors. Method 1300 may include displaying 1345 a variable with a high Priority Factor to a client. When displayed, the medium may be informed of the variable to inform or suggest to the medium or Patient Management Specialist of a priority question to be asked or information to be elicited from the patient. Method 1300 may include receiving 1350 a response to a question or information needed for or in relation to a variable from a client via an input device. Method 1300 may include sending 1355 the response from the input device to the system. Method 1300 may include receiving 1360 at the system the received response from the input device. Method 1300 may include associating 1365 with the variable having a high priority a client element related to the received response. Method 1300 may include updating 1370 the variable responsive to the client element received. Method 1300 may include assigning 1375 an updated priority factor to the updated variable. It will be understood that assigning 1375 an updated priority factor to the updated variable may include or may be based on the client element indicating, including or updating information of the variable in the patient record. The updated variable may be accessed, used and/or processing in and according to the adaptive data prioritization model for the patient. It will be understood that the adaptive data prioritization model for the patient may be updated in iterations on each occasion of making use of, accessing, and/or processing each updated variable. It will be understood, accordingly, that the adaptive data prioritization model for the patient may be updated on the fly, in real-time, or near real-time after each inputted answer for the adaptive data prioritization model to make use of, access, and/or process each updated variable.

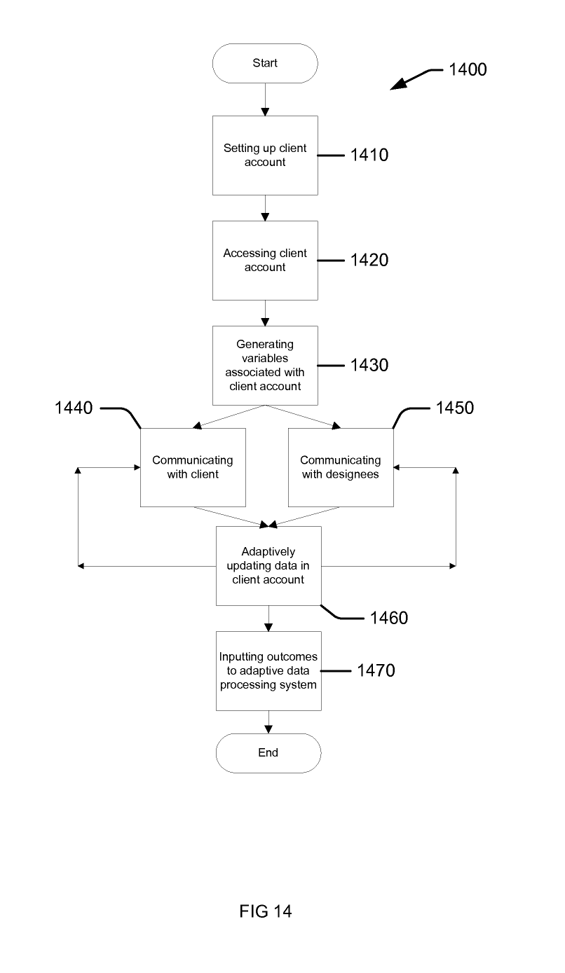

Illustrated in FIG. 14 is a method 1400 for management of behavioral health of an individual according to an embodiment of the present disclosure. It will be understood that, in embodiments, method 1400 may be performed with, supported on and enabled by operation of a suitable system 1500 (shown in FIG. 15) for management of behavioral health of an individual. It will be understood that method 1400 may include a suitable and compatible method 1100 for adaptive data prioritization as disclosed in further detail in FIG. 11 and method 1300 for management of behavioral health of an individual as disclosed in further detail in FIG. 13. Method 1400 may include setting up 1410 a client account for a patient; accessing 1420 a client account for the patient; generating 1430 variables associated with the client account of the patient; communicating 1440 with the client; communicating 1450 with designees for the client; adaptively updating 1460 data in the client account of a patient; and inputting 1470 outcomes to a method for adaptive data prioritization of the client. It will be understood that any suitable method 1100 for adaptive data prioritization of the client, as shown in FIG. 11, may be utilized in relation to method 1400 for management of behavioral health of an individual.

Illustrated in FIG. 15 is a system 1500 for management of behavioral health of an individual, according to an embodiment of the present disclosure. It will be understood that in the specific illustrated embodiment, system 1500 for management of behavioral health of an individual may include, incorporate and may be compatible with a suitable system 1200 (shown in FIG. 12) for performing adaptive data prioritization. In an embodiment, system 1500 for management of behavioral health of an individual may include input device 1510 in communication with system 1520 having database 1540, processor 1530 and model 1550. Input device 1510 may be in communication with output device 1560. Output device 1560 may be in communication with processor 1530 of system 1520, and with input device 1510, for receiving and outputting or providing information, data and/or instructions. It will be understood that in embodiments system 1500 for managing behavioral health of an individual may be suitable and arranged for enabling, supporting, processing and/or performing method 1300 for managing behavioral health of an individual as shown in FIG. 13.

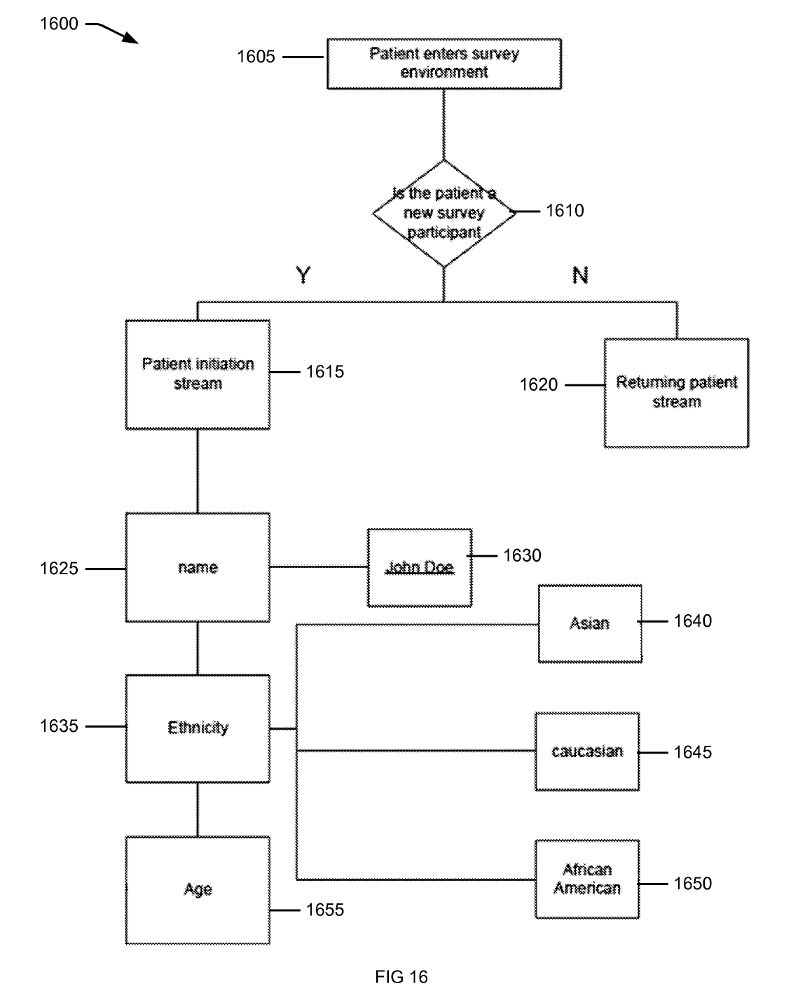

FIG. 16 presents an exemplary methodology for conducting an initial questioning of a target under a new target stream using a system of the present disclosure. In this exemplary embodiment, the target may be queried to determine if the target is a new 1615 or returning 1620 target. Upon the determination that the target is a new target, the target may be asked a serious of initiation or fixed questions 1625, 1635 and 1655. The responses to these questions may include both analog i.e. descriptive responses 1630, i.e. name is John Doe, and dialog responses or set parameter responses 1640, 1645, 1650, i.e. ethnicity being one of: Asian, Caucasian, African American, etc. One or more of these initiation and/or fixed questions may result in an attribute being applied to the target (e.g., the target's gender, ethnicity, age, etc., may be stored in association with the target, such that these and other attributes could be used to determine the usability of future questions.)

What has been described and illustrated herein is an embodiment of the invention along with some of its variations. The terms, descriptions and figures used herein are set forth by way of illustration only and are not meant as limitations. Those skilled in the art will recognize that many variations are possible within the spirit and scope of the invention in which all terms are meant in their broadest, reasonable sense unless otherwise indicated. Any headings utilized within the description are for convenience only and have no legal or limiting effect.

While the disclosed subject matter has been described with respect to a limited number of embodiments, the specific features of one embodiment should not be attributed to other embodiments of the disclosed subject matter. No single embodiment is representative of all aspects of the disclosed subject matter. Moreover, variations and modifications therefrom exist. For example, the disclosed subject matter described herein may comprise other components. Various additives may also be used to further enhance one or more properties. In some embodiments, the disclosed subject matter is substantially free of any additive not specifically enumerated herein. Some embodiments of the disclosed subject matter described herein consist of or consist essentially of the enumerated components. In addition, some embodiments of the methods described herein consist of or consist essentially of the enumerated steps. The claims to be appended later intend to cover all such variations and modifications as falling within the scope of the disclosed subject matter.

What is claimed is:

1. A method for generating an individual associated questionnaire, the method comprising:
receiving a client's credentials;
comparing said client's credentials to a database, said database comprising:
a list of questions; and
a least one rule associated with said question;
selecting at least a portion of said question list on the basis of said comparison;
presenting said selection and receiving a response;
revising said client's credentials on the basis of said response.

2. The method of claim 1, wherein the individual associated questionnaire relates to a questioning of a patient.

3. The method of claim 1, wherein the individual associated questionnaire relates to a questioning of an individual associated with a patient.

4. The method of claim 1, wherein said patient's credentials includes a risk rating.

5. The method of claim 1, wherein said risk rating relates to a statistical likelihood of self harm.

6. The method of claim 1, wherein said risk rating relates to a statistical likelihood of relapsing.

7. The method of claim 1, wherein presentation of said at least a portion of said question list occurs via a personal mobile device.

8. A non-transient computer readable medium containing instructions, said instructions when executed performing the steps of:
presenting on a GUI an input screen for receiving a client's credentials;
comparing said client's credentials to a database comprising:
a list of questions; and
a least one rule associated with said question;
selecting a portion of said question list on the basis of said comparison;
presenting on said GUI a portion of said question list and receiving a response; and
revising said client's credentials on the basis of said response.

9. The non-transient computer readable medium containing instructions of claim 8, wherein the individual associated questionnaire relates to a questioning of a patient.

10. The non-transient computer readable medium containing instructions of claim 8, wherein the individual associated questionnaire relates to a questioning of an individual associated with a patient.

11. The non-transient computer readable medium containing instructions of claim 8, wherein said patient's credentials includes a risk rating.

12. The non-transient computer readable medium containing instructions of claim 8, wherein said risk rating relates to a statistical likelihood of self harm.

13. The non-transient computer readable medium containing instructions of claim 8, wherein said risk rating relates to a statistical likelihood of relapsing.

14. The non-transient computer readable medium containing instructions of claim 8, wherein presentation of said at least a portion of said question list occurs via a personal mobile device.

15. A system for conducting an individual associated questionnaire, the system comprising:
a database comprising:
a list of clients and said clients credentials;
a list of questions and a list of rules associates with said questions;
a GUI interface for receiving an input, said input being at least one selected from the group of:
clients credentials;
a response to a question;
a processor, said processor capable of performing the steps of:
comparing an inputted client credentials to said client credentials stored in said database;
comparing said client credentials to said rules associated with said questions list;
selecting a list of questions associated with said client credentials.

16. The system of claim 15, wherein the individual associated questionnaire relates to a questioning of a patient.

17. The system of claim 15, wherein the individual associated questionnaire relates to a questioning of an individual associated with a patient.

18. The system of claim 15, wherein said patient's credentials includes a risk rating.

19. The system of claim 15, wherein said risk rating relates to a statistical likelihood of self harm.

20. The system of claim 15, wherein said risk rating relates to a statistical likelihood of relapsing.

21. The non-transient computer readable medium containing instructions of claim 8, wherein presentation of said at least a portion of said question list occurs via a personal mobile device.

22. A method for management of behavioral health of an individual, said method comprising:
generating an individual associated questionnaire, the method comprising:
receiving client credentials;
comparing said client credentials to a database, said database comprising:
established client credentials;
a list of questions; and
at least one rule associated with at least one question from said list of questions;
selecting at least a portion of said list of questions on the basis of said comparison;
presenting said selection; and
receiving a priority factor from an adaptive data prioritization model;
revising said client credentials on the basis of said response and said priority factor.

23. The method of claim 22, wherein the individual associated questionnaire relates to a questioning of a patient.

24. The method of claim 22, wherein the individual associated questionnaire relates to a questioning of an individual associated with a patient.

25. The method of claim 22, wherein said client credentials comprise a risk rating.

26. The method of claim 25, wherein said risk rating relates to a statistical likelihood of self harm.

27. The method of claim 25, wherein said risk rating relates to a statistical likelihood of relapsing.

28. The method of claim 22, wherein presentation of said at least a portion of said list of questions occurs via a personal mobile device.

29. A non-transient computer readable medium containing instructions, said instructions when executed performing the steps of:
presenting on a GUI an input screen for receiving client credentials;
comparing said client credentials to a database comprising:
established client credentials;
a list of questions; and
a least one rule associated with at least one question from said list of questions;
receiving a priority factors for each variable associated with said questions from an adaptive data prioritization model;
selecting a portion of said list of questions on the basis of said comparison and based on said priority factors associated with said questions;
presenting on said GUI said portion of said list of questions; and
receiving a response; and
revising said client credentials and said priority factors on the basis of said response.

30. The non-transient computer readable medium containing instructions of claim 29, wherein the individual associated questionnaire relates to a questioning of a patient.

31. The non-transient computer readable medium containing instructions of claim 29, wherein the individual associated questionnaire relates to a questioning of an individual associated with a patient.

32. The non-transient computer readable medium containing instructions of claim 29, wherein said client credentials comprise a risk rating.

33. The non-transient computer readable medium containing instructions of claim 32, wherein said risk rating relates to a statistical likelihood of self harm.

34. The non-transient computer readable medium containing instructions of claim 32, wherein said risk rating relates to a statistical likelihood of relapsing.

35. The non-transient computer readable medium containing instructions of claim 29, wherein presentation of said at least a portion of said list of questions occurs via a personal mobile device.

36. A system for management of behavioral health of an individual, said system comprising:
conducting an individual associated questionnaire, the system comprising:
a database comprising:
a list of clients;
client credentials;
a list of questions; and
a list of rules associated with said list of questions;
a GUI interface for receiving an input, said input being at least one selected from the group of:
client credentials; and
a response to a question;
a processor, said processor capable of performing the steps of:
comparing inputted client credentials to said client credentials stored in said database;
comparing said inputted client credentials to said list of rules associated with said list of questions;
selecting a second list of questions associated with said inputted client credentials.

37. The system of claim 36, wherein the individual associated questionnaire relates to a questioning of a patient.

38. The system of claim 36, wherein the individual associated questionnaire relates to a questioning of an individual associated with a patient.

39. The system of claim 36, wherein said client credentials comprise a risk rating.

40. The system of claim 39, wherein said risk rating relates to a statistical likelihood of self harm.

41. The system of claim 39, wherein said risk rating relates to a statistical likelihood of relapsing.
